(19) United States
(12) Patent Application Publication
(10) Pub. No.: US 2025/0363902 A1
(43) Pub. Date: Nov. 27, 2025

(54) SYSTEM AND METHOD FOR GENERATING STANDARDIZED PERFORMANCE METRICS FOR A USER BASED ON EDUCATION DATA RECEIVED FROM ONE OR MORE EDUCATION PLATFORMS

(71) Applicant: 2hr Learning, Inc., Austin, TX (US)

(72) Inventors: Isaac Squires, Austin, TX (US); Simon Said, Malta (MA); Bogdan Tenea, Bucharest (RO)

(73) Assignee: 2hr Learning, Inc., Austin, TX (US)

(21) Appl. No.: 19/218,322

(22) Filed: May 25, 2025

Related U.S. Application Data
(60) Provisional application No. 63/652,140, filed on May 27, 2024.

(51) Int. Cl. G09B 5/08; H04L 9/40

(52) U.S. Cl. CPC G09B 5/08; H04L 63/0428

(57) ABSTRACT

A system and method are disclosed for generating standardized performance metrics for a user based on educational data obtained from one or more educational platforms. The system and method involve collecting performance-related data using a data collector integrated within an educational activity to curriculum standard mapping module, where the data reflects the user's educational activities. A normalization module standardizes this data according to predefined teaching curriculum standards. The normalized data is then mapped by assigning weights and confidence scores to determine the user's mastery level over various curriculum standards. A data managing module organizes this mastery information for further analysis. Based on the mapped data, the educational activity to curriculum standard mapping module produces a comprehensive and standardized performance metric for the user. This enables consistent evaluation of a learner's proficiency across diverse educational platforms, aligning the output with recognized curriculum standards.

### CROSS-REFERENCE TO RELATED APPLICATION

This application claims the benefit under 35 U.S.C. § 119 (e) and 37 C.F.R. § 1.78 of U.S. Provisional Application No. 63/652,140, filed May 27, 2024, which is incorporated by reference in its entirety.

### FIELD OF THE INVENTION

The present invention relates in general to the field of electronics, and more specifically to system and method to integrate and normalize educational data received from one or more educational platforms to generate standardized performance metrics for users.

### BACKGROUND OF THE INVENTION

In the past, educators and administrators faced significant challenges in reconciling data from various educational platforms or using multiple, non-integrated systems to assess performance of students. This fragmented approach often led to incomplete insights and an inadequate understanding of a student's academic progress. The conventional methods lacked the sophistication to account for differences in scoring and content difficulty across educational platforms, resulting in inconsistent and incomparable data.

Conventionally, the task of data reconciliation was a manual and labor-intensive process. Educators had to collect data from various educational platforms each with its unique way of measuring and reporting student's performance. For instance, a student might use one platform for math practice, another for history, and yet another for science. Each platform might have different scoring systems, assessment styles, and performance metrics. To compile a comprehensive view of a student's progress, educators had to manually sift through these data points, to align them with the overall curriculum standards. This involved downloading reports from each platform, interpreting the data within the context of each educational platform and then mapping these scores to the relevant educational standards. This manual reconciliation was not only time-consuming but also prone to errors. Moreover, the educator, already burdened with heavy workloads, often found this task overwhelming, leading to delays and inaccuracies in tracking student progress.

Furthermore, due to the fragmented nature of data collection and reconciliation, educators often ended up with incomplete insights into student's performance. Each educational platform has different ways to store the performance data of the students and also have different ways of taking assessments. For example, a student might perform exceptionally well in a particular subject on one educational platform but struggle on another educational platform. Without integrated data, it was difficult to identify the discrepancies and understand the underlying reasons. This hinders the educators to identify areas where a student needed additional support or enrichment. As a result, personalized learning, which relies on a nuanced understanding of each student's strengths and weaknesses, was severely compromised.

Additionally, the lack of standardization in the conventional educational platforms posed another significant challenge. Each educational platform developed its own set of assessments, grading scales, and performance metrics, which did not necessarily align with the curriculum standards. Thus, making the educators interpret and reinterpret scores and grades, without a clear understanding of how they related to the curriculum.

### SUMMARY

A method for generating a standardized performance metrics for a user based on educational data received from one or more educational platforms includes executing code using one or more processors of a computer system to cause the computer system to perform operations that includes collecting educational data from one or more educational platforms using a data collector integrated within an educational activity to curriculum standard mapping module, wherein the educational data includes performance data associated with educational activities undertaken by the user across the educational platforms. The method also includes normalizing the collected educational data by a normalization module operatively coupled to the data collector, wherein normalization includes providing a definition to each educational data based on the standards of a teaching curriculum. The method also includes mapping the normalized educational data, wherein mapping includes assigning weights and confidence values to the normalized educational data for identifying mastery level obtained by the user on teaching curriculum standards. The method includes utilizing a data managing module to organize information related to mastery obtained by the user on various standards of the teaching curriculum through learning on the one or more educational platforms. The method also includes generating a standardized performance metrics of the user via the educational activity to curriculum standard mapping module based on the mapped educational data associated with educational activities of the user across the one or more educational platforms.

A system for generating a standardized performance metrics for a user based on educational data received from one or more educational platforms includes one or more processors; and a memory, coupled to the one or more processors, having code stored therein that when executed by the one or more processors causes the one or more processors to perform operations. The operation includes collecting educational data from one or more educational platforms using a data collector integrated within an educational activity to curriculum standard mapping module, wherein the educational data includes performance data associated with educational activities undertaken by the user across the educational platforms. The system also includes normalizing the collected educational data by a normalization module operatively coupled to the data collector, wherein normalization includes providing a definition to each educational data based on the standards of a teaching curriculum. The system also includes mapping the normalized educational data, wherein mapping includes assigning weights and confidence values to the normalized educational data for identifying mastery level obtained by the user on teaching curriculum standards. The system includes utilizing a data managing module to organize information related to mastery obtained by the user on various standards of the teaching curriculum through learning on the one or more educational platforms. The system also includes generating a standardized performance metrics of the user via the educational activity to curriculum standard mapping module based on the mapped educational data associated with educational activities of the user across the one or more educational platforms.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary standardized performance metrics generation system for tracking and assessing user progress on one or more educational platforms.

FIG. 2 depicts an exemplary standardized performance metrics generation process for tracking and assessing user progress on one or more educational platforms.

FIG. 3 depicts a standardized performance metrics generation progress for a user based on educational data received from one or more educational platforms, which is an embodiment of the standardized performance metrics generation process of FIG. 2.

FIG. 4 depicts an exemplary network environment in which the standardized performance metrics generation system of FIG. 1 and the standardized performance metrics generation process of FIG. 2 may be practiced.

FIG. 5 depicts an exemplary computer system.

### DETAILED DESCRIPTION

A standardized performance metrics generation system to generate standardized performance metrics based on the educational data received from one or more learning platforms. The educational activity to curriculum standard mapping module displays the generated standardized performance metrics to the user on a user interface. The standardized performance metrics generation system using adaptive learning further includes one or more processors that are used for executing code of a computer system to cause the computer system to perform operations.

The standardized performance metrics generation system employs a data collector for collecting educational data from one or more educational platforms. The data collector utilizes a plurality of APIs by the data collector to collect educational data from one or more educational platforms. Typically, the educational data includes performance data associated with educational activities undertaken by the user across one or more educational platforms. The educational data includes one or more topics studied by the user, questions attempted by the user, quiz or test taken by the user on one or more educational platforms. The educational data collected by the data collector is fed to a normalization module for normalizing the collected educational data. The normalization includes providing a definition to each educational data based on the standards of a teaching curriculum.

The normalized data is mapped by assigning weights and confidence values for identifying mastery level obtained by the user on teaching curriculum standards. Moreover, the standardized performance metrics generation system utilizes a data structure to organize information related to mastery obtained by the user on various standards of the teaching curriculum. The standardized performance metrics generation system utilizes the educational activity to curriculum standard mapping module to generate the standardized performance metrics associated with the user.

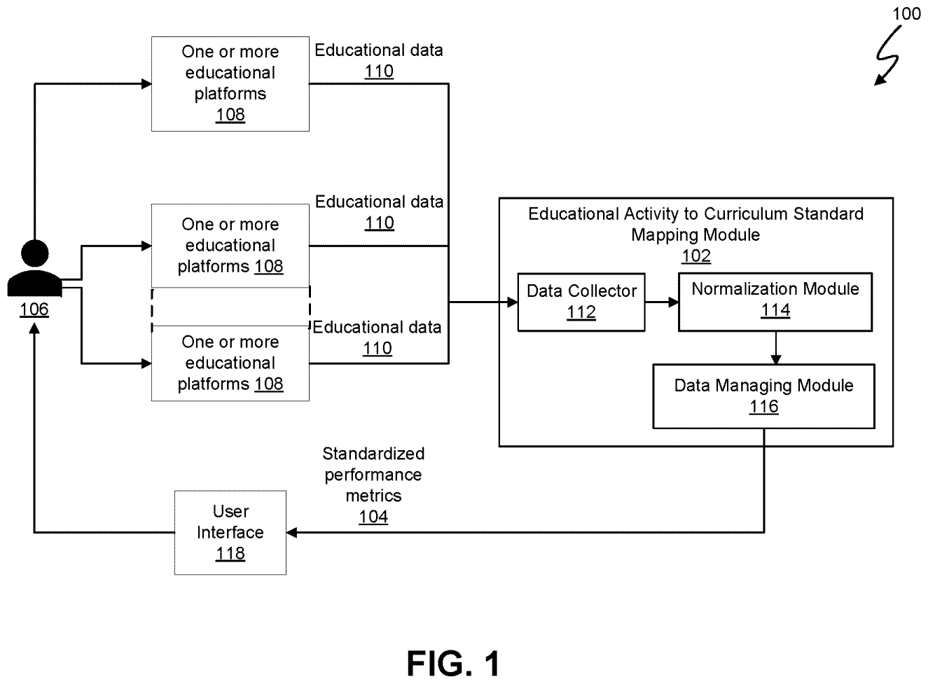

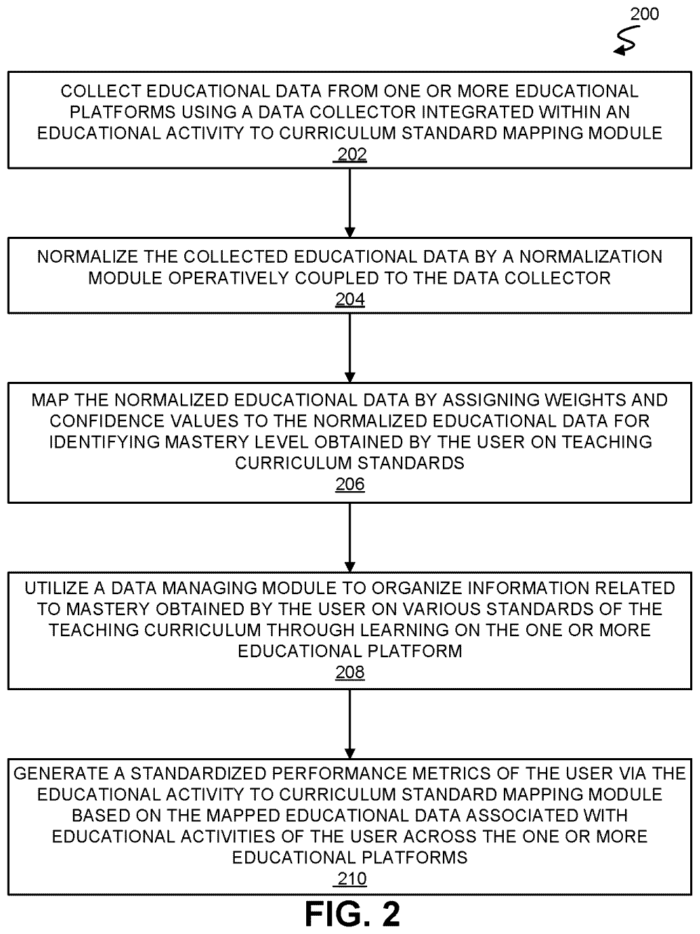

FIG. 1 depicts an exemplary standardized performance metrics generation system 100 for tracking and assessing user progress on one or more educational platforms. FIG. 2 depicts an exemplary standardized performance metrics generation process 200 utilized by standardized performance metrics generation system 100.

The educational activity to curriculum standard mapping module 102 designed for generating standardized performance metrics 104 for a user 106 based on educational data received from one or more educational platforms 108. The educational activity to curriculum standard mapping module 102 collects the educational data 110 from one or more educational platforms 108 via a data collector 112, the one or more educational platforms 108 include online learning environments, traditional classroom management systems, and other educational tools that track the user 106 activities. The educational data 110 collected encompasses educational metrics, such as test scores, assignment grades, time spent on tasks, and completion rates of learning modules. Typically, the educational activity to curriculum standard mapping module 102 utilize a normalization module 114 and data managing module 116 to clean, normalize, and harmonize the incoming educational data 110 by removing any errors, duplicates, or irrelevant information and converting it into a common format and scale, allowing for accurate comparisons. For instance, test scores from one platform might be on a scale of 1 to 100, while another uses letter grades such as A, B, C, and the like. The educational activity to curriculum standard mapping module 102 converts these into a standardized format.

In at least one embodiment, the educational activity to curriculum standard mapping module 102 utilizes machine learning algorithms to analyze the educational data 110 and identify patterns and correlations. In at least one embodiment, the machine learning algorithms include supervised learning models, which are trained on labeled datasets to predict outcomes, and unsupervised learning models, which discover hidden patterns in the educational data 110 without pre-existing labels to identify areas where the user 106 excels or struggles. The educational activity to curriculum standard mapping module 102 generates the standardized performance metrics 104, which include overall academic performance scores, proficiency levels in specific subjects, engagement levels, and progress over time. The standardized performance metrics 104 are designed to provide a holistic view of the user's performance, capturing grades and learning behaviors. The educational activity to curriculum standard mapping module 102 utilizes statistical methods and machine learning techniques, for example, regression analysis to predict future performance based on past data.

Referring to FIGS. 1 and 2, in operation 202, the educational data 110 is collected from one or more educational platforms 108 by using the data collector 112. The data collector 112 is integrated within the metrics generation module 102. The one or more educational platforms, such as IXL by Paul Mishkin, Khan Academy by Sal Khan, Duolingo. The educational data includes performance data associated with educational activities undertaken by the user 106 across the educational platforms 108. Typically, the identification and selection of the one or more educational platforms 108 from which the educational data will be gathered is analyzed and selected. The one or more educational platforms 108 have their own way of capturing and storing educational data related to user activities, such as logins, time spent on tasks, quiz scores, assignment submissions, and participation in discussion forums.

The data collector 112 is deployed to interface with the one or more educational platforms 108. The data collector 112 is configured to extract relevant educational data from the databases of various one or more educational platforms 108. The data collector 112 begins the process of data extraction by connecting to the one or more educational platforms 108 and retrieving educational data in real-time. For collecting educational data from one or more educational platforms 108 the data collector 112 utilizes a plurality of APIs (Application Programming Interfaces). The plurality of APIs allows seamless integration and efficient data gathering from the one or more educational platforms 108, each with its unique data structures and formats. Typically, the data collector 112 establishes connections with each platform from one or more educational platforms 108 and ensures secure data access. The data collector 112 sends API requests to the one or more educational platforms 108, specifying the types of data to fetch therefrom. As the one or more educational platforms 108 respond to the API requests, the data collector 112 processes the incoming data, ensuring it is accurately captured and stored.

The data collector 112 parses incoming data such as education data, extracting relevant details. The use of plurality of APIs allows the data collector 112 to gather a wide range of data points from the one or more educational platforms 108 simultaneously, enabling a comprehensive and detailed understanding of the user's learning journey. Moreover, the utilization of plurality of APIs ensures that the data collection process is dynamic and adaptable. The plurality of APIs provides real-time data access. The real-time data access is essential for timely interventions and personalized learning experiences.

The educational data encompasses information related to a user's learning activities across one or more educational platforms 108. The educational data may include the topics studied by user 106, providing insight into the subjects and content areas the user 106 have engaged with. The educational data also comprises the questions attempted by the user 106, that indicate their areas of focus, strengths, and areas needing improvement. Additionally, the educational data includes details of quizzes or tests taken by the user 106, reflecting the performance and mastery level of the subject. The educational data may also include quizzes or tests attempted by the user outside the learning platform environment. This encompasses assessments taken in various offline settings, such as paper-based tests administered in a classroom, standardized exams, or practice quizzes completed independently.

Moreover, the educational data also includes performance data such as test scores, grades, completion rates of learning modules, participation rates, engagement metrics, and time spent on different activities on the one or more education platforms 108. The educational data is utilized to identify patterns and trends, such as to identify areas where the user 106 excels or struggles, predicting future performance based on past data, and recommending personalized learning paths. Based on the educational data extracted from the one or more educational platforms 108, the one or more educational platforms 108 allows in generation of the standardized performance metrics 104 for comparing user performance across one or more educational platforms 108. The standardized performance metrics 104 include overall academic performance scores, proficiency levels in specific subjects, engagement levels, and learning progress over time.

In operation 204, the collected educational data is normalized by a normalization module 114 received from the data collector 112. Typically, the educational data 110 from the one or more educational platforms 108 is collected, the educational data 110 includes quantitative metrics such as test scores, assignment grades, and time spent by the user 106 on the one or more platforms 108. The data collector 112 gathers the educational data 110, which is then fed into the normalization module 114. The normalization module 114 identifies and categorizes the types of educational data 110 collected. The educational data 110 is analyzed to understand its nature, format, and context. For example, test scores might be represented as percentages on one platform, letter grades on another, and numeric scores on yet another. Similarly, qualitative data might be text-based comments or feedback, requiring different handling techniques. The normalization module 114 is configured to process the varied educational data 110 types.

The process of normalization minimizes redundant educational data 110 based on the standards of a teaching curriculum. The normalization module 114 is configured to map the raw data to a set of predefined standards and criteria that are used to evaluate educational performance within the curriculum. Typically, the normalization module 114 maps the educational activities undertaken by the user 106 across the one or more educational platforms 108 to educational standards. The educational standards include Common Core State Standards (CCSS), Next Generation Science Standards (NGSS), College Board, and so on which house comprehensive details of each topic included in the curriculum. The normalization module 114 standardizes and aligns the educational data 110 of user activities, such as lessons completed, assessments taken, and skills practiced, with the relevant educational standards. The normalization module 114 ensures that the educational data 110 from the one or more educational platforms 108 are consistently interpreted and assessed against educational standards, facilitating a coherent and comprehensive evaluation of the academic progress of the user 106.

For example, if the curriculum uses a grading scale of ‘A’ to ‘F’, the normalization module 114 will convert percentage scores and numeric scores into corresponding letter grades. This mapping process ensures that all data is aligned with the same evaluation framework, making it possible to compare and analyze data consistently. In at least one embodiment, the normalization module 114 first cleans the raw educational data 110 received from the data collector 112 to remove any errors, duplicates, or irrelevant information to ensure the accuracy and reliability of the normalized data. Moreover, the data cleaning involves correcting typographical errors, resolving inconsistencies, and filling in missing values using appropriate techniques such as imputation. Furthermore, the raw data is then transformed into a common format. This transformation includes converting data types, standardizing units of measurement, and applying consistent scales. Additionally, the normalization module 114 maps the received educational data 110 to the corresponding standard in the teaching curriculum by defining the relationship between the received educational data and the curriculum standards. For example, a user 106 score of ‘85%’ might be mapped to a grade of ‘B’ according to the curriculum grading scale.

The normalization module 114 contextualizes the educational data 110 by incorporating additional information that provides context to the raw data. For example, the normalization module 114 takes into account the difficulty level of an assignment or the weight of a test score in the overall grade calculation. Once the educational data 110 is cleaned, transformed, mapped, and contextualized, to forms mapped educational data. The mapped educational data is stored in a structured format that allows for easy access and querying. The normalization of educational data 110 ensures that educational data 110 from one or more educational platforms 108 may be compared and analyzed consistently, providing a comprehensive view of performance of the user 106 across different educational activities. Moreover, the normalization module 114 aligns the collected educational data 110 with the standards of the teaching curriculum, ensuring that the data accurately reflects the user's performance in relation to the curriculum. For example, if the curriculum emphasizes critical thinking skills, the normalization module 114 can ensure that data related to critical thinking assessments is accurately represented and evaluated. The normalization module 114 is configured to identify patterns and relationships between the educational data 110 from the one or more educational platforms 108 and educational standards. The normalization module 114 analyzes educational data 110, such as student performance metrics and activity logs, to detect underlying trends and correlations. In at least one embodiment, the normalization module 114 utilizes the machine learning module to automatically map educational activities to curriculum standards, ensuring consistent and accurate alignment.

Moreover, the educational activity to curriculum standard mapping module 102 is configured to maintain data privacy and security. The data collector 112 employs robust encryption methods to protect the educational data 110 during transmission and storage, ensuring that the educational data 110 is accessible only to authorized individuals. Typically, a network infrastructure is configured for secure data transfer between one or more educational platforms 108, the data collector 112, and the data normalization module 114. The network infrastructure employs encryption protocols to ensure data security and integrity during data transfer. The educational data 110 transmitted across is encrypted, or converted into a secure code, to prevent unauthorized access and protect sensitive information to maintain the confidentiality and integrity of the educational data.

In operation 206, the normalized educational data is mapped. The mapping includes assigning weights and confidence values to the normalized educational data for identifying the mastery level obtained by the user 106 on teaching curriculum standards. The normalized educational data received from the normalization module 114 is a standardized and cleaned data to ensure consistency and comparability. The normalized educational data represents the user 106 performance, such as test scores, assignment grades, or other measurable educational activities. Typically, the mapping of the normalized educational data is done to understand the teaching curriculum standards. The teaching curriculum standards define the expected knowledge, skills, and competencies that the user 106 should achieve at different stages of their education journey. The teaching curriculum standards provide a benchmark against which user 106 performance can be measured. Typically, the teaching curriculum standards can vary significantly depending on the subject and grade level.

Based on the teaching curriculum standards, the mapping of the normalized educational data is done. The mapping includes assigning weights and confidence values to the normalized educational data. The weights reflect the importance of each type of data from normalized educational data in assessing mastery level of a particular standard. For example, test scores are given more weight than assignments because tests are typically more comprehensive and standardized measures of understanding. The process of assigning weights involves determining which aspects of the educational data 110 are most indicative of mastery level. In addition to weights, the confidence values indicate the reliability and certainty of the normalized educational data in reflecting the user's true performance. If the user 106 consistently performs well on a particular type of assessment, the confidence values in those results increase. Conversely, if there are significant fluctuations in performance the confidence value might be lower.

With weights and confidence values assigned, the normalized educational data is mapped to the teaching curriculum standards to calculate mastery levels. Calculating the mastery levels involves aggregating the weighted data and adjusting for confidence values to derive a composite score for each standard. The composite score reflects the user's overall performance and the reliability of that performance in relation to the specific standard. The calculated mastery levels are presented to the user 106. In at least one embodiment, the mastery levels are displayed on a user interface 118. The user interface 118 includes visualization tools such as dashboards to illustrate mastery levels clearly and intuitively. The visualization tools can use visual elements like color coding, graphs, and progress bars to represent mastery levels. For example, the user interface 118 shows a mastery level of a user 106 for each curriculum standard on a scale of 0 to 100, with different colors indicating different levels of mastery (e.g., red for below standard, yellow for approaching standard, green for meeting standard, and blue for exceeding standard). The process of mapping educational data 110 and assessing mastery levels is dynamic and iterative. The normalization module 114 and mapping processes are flexible to accommodate the change in teaching curriculum standards, ensuring that the assessment of mastery levels remains aligned with current educational standards.

In operation 208, the data managing module 116 is utilized to organize information related to mastery obtained by the user 106 on various standards of the teaching curriculum standards through learning on the one or more educational platforms 108. The data managing module 116 is capable of organizing the educational data 110 from the one or more educational platforms 108, providing a coherent view of the user 106 progress and achievements across different teaching curriculum standards to obtain mastery levels of the user 106. The data managing module 116 identifies the key elements to organize information such as user information, educational platforms, teaching curriculum standards and performance data. The user information comprises details about the user 106, such as name, unique identifier, enrollment details, and demographic information. The educational platforms provide information about the different educational platforms the user 106 interacts with. The teaching curriculum standards include detailed descriptions of the curriculum standards, such as learning objectives, competencies, and performance criteria for each standard. The performance data reflects the performance of the user 106 in test scores, assignment grades, and so forth.

The data managing module 116 uses a database model for indexing, and query optimization to help manage the real-time updates and retrieval of the mastery level of the user 106. The database is organized into tables, with each table representing a specific element (such as, users, platforms, standards, performance data). Typically, the performance data is mapped to specific teaching curriculum standards to assess mastery level. The mapping involves linking each performance data point to the corresponding curriculum standards and providing contextual information such as the type of assessment, the weight of the assessment, and the confidence value. This linkage enables the calculation of mastery levels for each standard. Notably, each assessment is assigned the weight based on its importance in the curriculum. For example, final exams might carry more weight than weekly quizzes. Moreover, each assessment is also assigned the confidence value. The data managing module 116 aggregates the weighted scores and adjusts for confidence values to calculate a composite score for each standard. The composite score represents the user's overall performance and mastery level for the standard. By analyzing the mastery levels, the educational activity to the curriculum standard mapping module 102 identifies areas where the user 106 excels and areas where additional support is needed.

In operation 210, generate the standardized performance metrics 104 of the user 106 via the educational activity to curriculum standard mapping module 102 based on the mapped educational data associated with educational activities of the user 106 across the one or more educational platforms 108. The educational activity to curriculum standard mapping module 102 generates the standardized performance metrics 104 that reflect the mastery level of user 106 based on their educational activities. The standardized performance metrics 104 of the user 106 refers to a unified and consistent metric that evaluates the proficiency, progress, and mastery level of the user 106 of specific teaching curriculum standards across one or more educational platforms 108. The standardized performance metrics 104 is designed to provide a comparable assessment of the user 106 academic performance based on the mapped educational data associated with educational activities of the user 106.

The educational activity to curriculum standard mapping module 102 consider the educational data 110 that includes test scores, assignment grades, participation records, time spent on the one or more educational platforms 108. The mapped educational data includes weights and confidence values that indicate the importance of each data point. The educational activity to curriculum standard mapping module 102 use the weights and confidence values to calculate the standardized performance metrics 104. The educational activity to curriculum standard mapping module 102 utilizes weighted performance data and adjusts for confidence values to derive a single score that represents the mastery level of the user 106 for each standard.

The educational activity to curriculum standard mapping module 102 is configured to comprehend the specified tasks and objectives by utilizing the data managing module 116, identifying key components, such within the educational data 110. The educational activity to curriculum standard mapping module 102 accesses the mapped educational data associated with the user 106 from the one or more educational platforms 108. The retrieved educational data undergoes preprocessing to cleanse, normalize, and format. In at least one embodiment, the educational activity to curriculum standard mapping module 102 employs machine learning algorithms on the educational data 110 to generate the standardized performance metrics 104.

The educational activity to curriculum standard mapping module 102 calculates standardized performance metrics 104 associated with the user 106 by aggregating, analyzing, and synthesizing the preprocessed educational data 110 to derive meaningful indicators of the user's educational proficiency and attainment. The standardized performance metrics 104 encompass proficiency levels, mastery level, learning progress, and performance trends of the user 106 across different teaching curriculum standards. Typically, the educational activity to curriculum standard mapping module 102 ensures alignment with the predefined teaching curriculum standards. The alignment enables contextual interpretation of the standardized performance metrics 104 within the educational framework, facilitating meaningful assessment of the user's progress and achievement relative to the teaching curriculum standards. Moreover, the educational activity to curriculum standard mapping module 102 normalizes and standardizes the standardized performance metrics 104 to ensure consistency, comparability, and interpretability by applying scaling factors, normalization techniques, or statistical methods. In at least one embodiment, the educational activity to curriculum standard mapping module 102 incorporates quality assurance mechanisms to validate the accuracy, reliability, and integrity of the standardized performance metrics by cross-validation, error checking, and sensitivity analysis to detect anomalies, discrepancies, or data inconsistencies.

The standardized performance metrics system 100 further comprises one or more servers configured for storing educational data 110 and standardized performance metrics 104. The one or more servers are arranged to handle vast amounts of education data 110 received from one or more educational platforms 108. The one or more servers are equipped with sufficient storage capacity to accommodate the volumes of educational data 110 and standardized performance metrics 104. Moreover, the one or more servers is scalable, allowing for additional storage to handle increasing amounts of educational data 110 and standardized performance metrics 104 over time. Furthermore, the one or more servers provide a failover mechanism in case of hardware failure, ensuring that education data 110 and standardized performance metrics 104 remains accessible and the standardized performance metrics system 100 continues to operate smoothly without interruption. The one or more servers are also optimized for performance, enabling fast retrieval and processing of educational data 110 and standardized performance metrics 104. In at least one embodiment, the one or more servers includes database management systems (DBMS) to organize and manage the educational data 110 and standardized performance metrics 104 to ensure the educational data 110 and standardized performance metrics 104 is stored in a structured and accessible manner.

Upon generation of the standardized performance metrics 104, the educational activity to curriculum standard mapping module 102 generates visual representations, such as charts, graphs, heatmaps, or dashboards, to illustrate the performance of the user 106. The visualization of the standardized performance metrics 104 associated with the user 106 is displayed on the user interface 118 and provides tools for analyzing the standardized performance metrics 104 relative to the educational standards. The user interface 118 is designed to be intuitive and interactive, offering a comprehensive view of the user's progress across different subjects and learning activities. The standardized performance metrics 104 include scores from quizzes and tests, completion rates of educational modules, proficiency in specific skills or concepts, and overall progress in relation to the curriculum standards. In at least one embodiment, the standardized performance metrics 104 are displayed in formats such as charts, graphs, dashboards, and tables, which make it easier to understand complex data at a glance.

The below is a pseudo code for generating standardized performance metrics 104 for a user 106 based on educational data 110 received from one or more educational platforms 108:
#Function to aggregate data from various learning platforms def aggregate_data(platform_data_sources):
   ″″″
   Aggregates data from multiple learning platforms.
   Each platform_data_source is a dictionary containing platform-specific data.
   ″″″
   aggregated_data=[ ]
   for platform_data in platform_data_sources:
      #Normalize data structure across platforms
      standardized_data=normalize_data(platform_data)
      aggregated_data.append(standardized_data)
   return aggregated_data
#Function to normalize data from a single platform
def normalize_data(platform_data):
   ″″″
   Normalizes data to a standard format.
   Adjusts scores, weights activities, and maps equivalencies between platforms.
   ″″″
   normalized_data={ }
   #Example normalization techniques
   for skill, metrics in platform_data.items( ):
      #Scaling based on difficulty
      metrics[‘score’]=scale_score(metrics[‘score’], metrics[‘difficulty’])
      #Weighting based on relevance to standards
      metrics[‘weighted_score’]=weight_score(metrics[‘score’], metrics[‘relevance’])
      normalized_data[skill]=metrics
   return normalized_data
#Function to scale scores based on difficulty
def scale_score(score, difficulty):
   ″″″
   Scales the score based on the difficulty of the learning material.
   ″″″
   #Scaling logic based on difficulty
   scaled_score=score/difficulty
   return scaled_score
#Function to weight scores based on relevance
def weight_score(score, relevance):
   ″″″
   Weights the score based on the relevance to specific standards.
   ″″″
   #Weighting logic based on relevance
   weighted_score=score*relevance
   return weighted_score
#Function to map normalized data to Common Core standards
def map_to_standards(normalized_data, curriculum_alignment_data):
   ″″″
   Maps normalized data to specific Common Core standards using predefined mappings.
   ″″″
   mapped_data={ }
   for skill, metrics in normalized data.items ( ):
      #Utilize established mappings to align skills with standards
      standard=curriculum_alignment_data.get(skill)
      if standard:
         mapped_data[standard]=metrics
   return mapped_data
#Function to update Skill Stack with mapped data
def update_skill_stack(mapped_data, skill_stack):
   ″″″
   Updates the Skill Stack with the latest mapped data.
   ″″″
   for standard, metrics in mapped_data.items ( ):
      #Update or add new mastery levels to the Skill Stack
      skill_stack[standard]=metrics[‘weighted_score’]
   return skill_stack

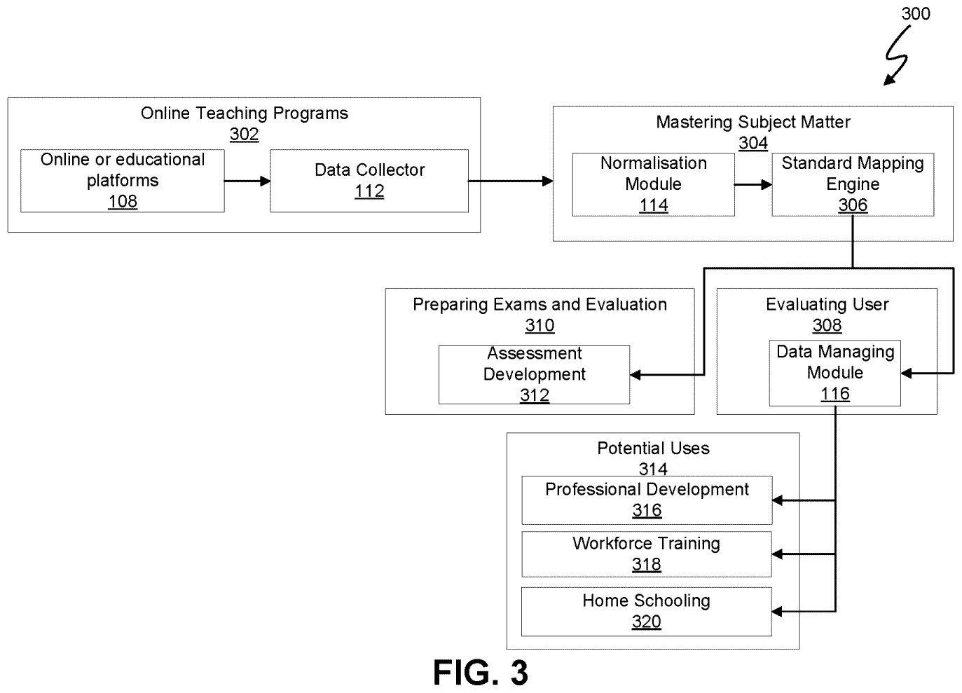

Referring to FIG. 3 depicts a standardized performance metrics generation process 300 for a user 106 based on educational data 110 received from one or more educational platforms 108, which is an embodiment of the standardized performance metrics generation process 200 of FIG. 2. As shown, an online teaching program 302 comprises one or more educational platforms 108 and the data collector 112. Typically, the online teaching program 302 is a method of delivering educational content and instruction via the internet to the user 106. The online teaching program 302 involves virtual classrooms, video lectures, interactive activities, and online assessments to allow the users 106 to participate in learning activities from anywhere with an internet connection, making education more accessible and flexible. The data collector 112 is configured to extract the educational data 110 from the one or more educational platforms 108.

The extracted educational data 110 is provided to a mastering subject matter 304. The mastering subject matter 304 involves acquiring a comprehensive and in-depth understanding of a particular topic by utilizing the extracted educational data 110. The mastering subject matter 304 includes the normalization module 114 and standard mapping engine 306. The normalization module 114 normalized the extracted educational data 110 and the standard mapping engine 306 visualizes and analyzes the normalized educational data. The standard mapping engine 306 maps the normalized educational data with the teaching curriculum standard. The mapped educational data is provided to the data managing module 116 to organize information related to mastery obtained by the user 106 on various standards of the teaching curriculum standards through learning on the one or more educational platforms 108 for evaluating user 308.

Moreover, based on the mapped education data preparing exams and evaluations 310 is done by preparing the assessment development 312. The preparing exams and evaluations 310 involves assessments developing 312 such as quizzes tests that measure the understanding of the user 106. The preparing exams and evaluations 310 include creating questions that assess different levels of understanding, from basic knowledge to mastery level of the user 106. The data managing module 116 has potential uses 314, such as professional development 316, workforce training 318, and home schooling 320. The professional development 316 refers to the process of improving and increasing the knowledge, skills, and abilities through various learning opportunities, such as workshops, training programs, conferences, and continuing education. The professional development 316 helps the user 106 to develop new skills. The workforce training 318 is a training provided to the user 106 with knowledge, skills, and competencies needed to perform specific operations. The home schooling 320 is a process in which the school related education is provided to the user 106 at home.

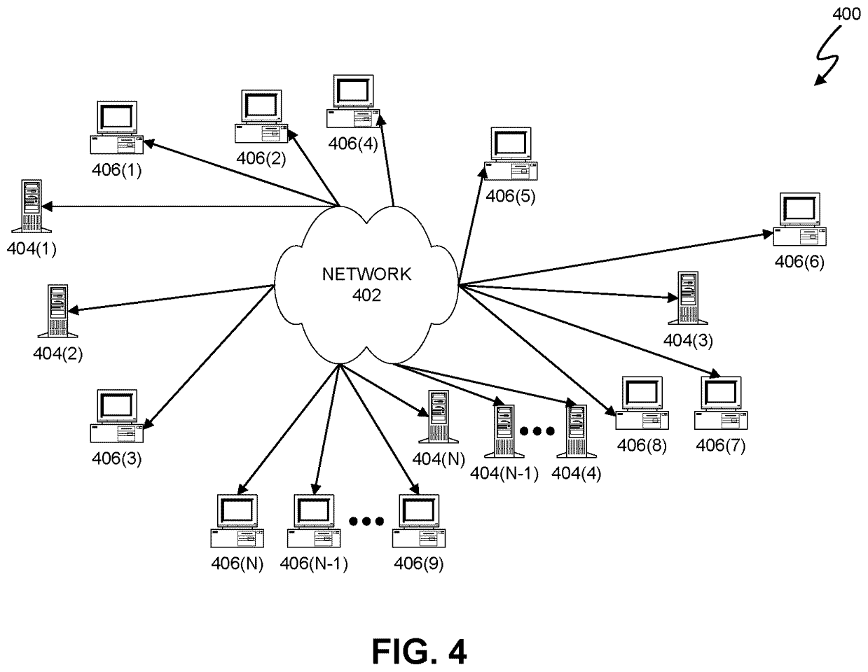

FIG. 4 is a block diagram illustrating a network environment in which a standardized performance metrics generation system 100 and standardized performance metrics generation process 200 may be practiced. Network 402 (e.g. a private wide area network (WAN) or the Internet) includes a number of networked server computer systems 404(1)-(N) that are accessible by client computer systems 406(1)-(N), where N is the number of server computer systems connected to the network. Communication between client computer systems 406(1)-(N) and server computer systems 404(1)-(N) typically occurs over a network, such as a public switched telephone network over asynchronous digital subscriber line (ADSL) telephone lines or high-bandwidth trunks, for example communications channels providing T1 or OC3 service. Client computer systems 406(1)-(N) typically access server computer systems 404(1)-(N) through a service provider, such as an internet service provider (“ISP”) by executing application specific software, commonly referred to as a browser, on one of client computer systems 406(1)-(N).

Client computer systems 406(1)-(N) and/or server computer systems 404(1)-(N) are specialized computer programmed to improve conventional computer systems to implement and utilize the standardized performance metrics generation system 100 and standardized performance metrics generation process 200. The type of computer system that can be specially programmed to implement and utilize the standardized performance metrics generation system 100 and standardized performance metrics generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the standardized performance metrics generation system 100 and standardized performance metrics generation process 200 can be implemented using code stored in a tangible, non-transient computer readable medium and executed by one or more processors. In at least one embodiment, the standardized performance metrics generation system 100 and standardized performance metrics generation process 200 can be implemented completely in hardware using, for example, logic circuits and other circuits including field programmable gate arrays.

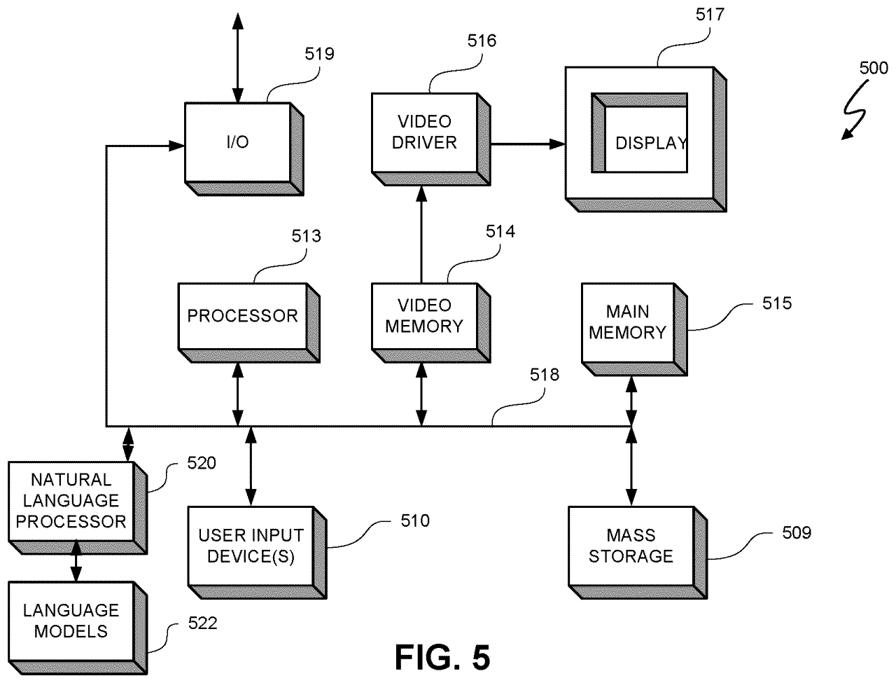

Embodiments of the standardized performance metrics generation system 100 and standardized performance metrics generation process 200 can be implemented on a computer system such as a special-purpose, special-programmed computer 500 illustrated in FIG. 5. Input user device(s) 510, such as a keyboard and/or mouse, are coupled to a bi-directional system bus 518. The input user device(s) 510 are for introducing user input to the computer system and communicating that user input to processor 513. The computer system of FIG. 5 generally also includes a non-transitory video memory 514, non-transitory main memory 515, and non-transitory mass storage 509, all coupled to bi-directional system bus 518 along with input user device(s) 510 and processor 513. The mass storage 509 may include both fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU Y09, main memory 515, video memory 514 and mass storage 509, where “n” is, for example, 32 or 64. Alternatively, multiplex data/address lines may be used instead of separate data and address lines.

I/O device(s) 519 may provide connections to peripheral devices, such as a printer, and may also provide a direct connection to a remote server computer systems via a telephone link or to the Internet via an ISP. I/O device(s) 519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 509, into main memory 515 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the display 517. Video amplifier 516 is well known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. The standardized performance metrics generation system 100 and standardized performance metrics generation process 200 may be implemented in any type of computer system or programming or processing environment. It is contemplated that the standardized performance metrics generation system 100 and standardized performance metrics generation process 200 might be run on a stand-alone computer system, such as the one described above. The standardized performance metrics generation system 100 and standardized performance metrics generation process 200 might also be run from a server computer systems system that can be accessed by a plurality of client computer systems interconnected over an intranet network. Finally, the standardized performance metrics generation system 100 and standardized performance metrics generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for generating a standardized performance metrics for a user based on educational data received from one or more educational platforms, the method comprising:
executing code using one or more processors of a computer system to cause the computer system to perform operations comprising:
collecting educational data from one or more educational platforms using a data collector integrated within an educational activity to curriculum standard mapping module, wherein the educational data includes performance data associated with educational activities undertaken by the user across the 9 educational platforms;
normalizing the collected educational data by a normalization module operatively coupled to the data collector, wherein normalization includes providing a definition to each educational data based on the standards of a teaching curriculum;
mapping the normalized educational data, wherein mapping includes assigning weights and confidence values to the normalized educational data for identifying mastery level obtained by the user on teaching curriculum standards;
utilizing a data managing module to organize information related to mastery obtained by the user on various standards of the teaching curriculum through learning on the one or more educational platforms;
generating a standardized performance metrics of the user via the educational activity to curriculum standard mapping module based on the mapped educational data associated with educational activities of the user across the one or more educational platforms.

2. The method of claim 1, wherein the educational data may include one or more topics studied by the user, questions attempted by the user, quiz or test taken by the user on the one or more educational platforms.

3. The method of claim 1, wherein the educational data may include quizzes or tests attempted by the user outside the learning platform environment.

4. The method of claim 1, wherein collecting educational data from the one or more educational platforms further comprises utilizing a plurality of APIs by the data collector to collect educational data from the one or more educational platforms.

5. The method of claim 1, wherein receiving the collected educational data by the normalization module further includes mapping the educational activities undertaken by the user across the one or more educational platforms to educational standards.

6. The method of claim 1, wherein mapping further comprises:
assigning the weights based on difficulty or complexity level of the educational activities undertaken by the user on the one or more educational platforms; and
assigning confidence value to the educational data based on reliability of the data obtained from the one or more educational platforms.

7. The method of claim 1, wherein mapping further includes assigning scores to the educational data based on performance metrics associated with the user across one or more educational platforms for enhancing the skill and mastery level.

8. The method of claim 1, further comprising:
one or more servers for processing the educational data, wherein the one or more servers is configured for storing the educational data and the standardized performance metrics.

9. The method of claim 1, further comprising:
incorporating a network infrastructure configured for secure data transfer between one or more educational platforms, data collector, and data normalization module, wherein the network infrastructure employs encryption protocols to ensure data security and integrity during data transfer.

10. The method of claim 1, wherein the normalization module includes a machine learning module configured to identify patterns and relationships between the educational data from the one or more educational platforms and educational standards.

11. The method of claim 1, further comprising:
displaying the standardized performance metrics associated with the user on a user interface and provides tools for analyzing the standardized performance metrics relative to the educational standards.

12. A system for generating a standardized performance metrics for a user based on educational data received from one or more educational platforms, the system comprising:
one or more processors;
memory, operatively coupled to the one or more processors that when executed cause the one or more processors to perform operations comprising:
collecting educational data from one or more educational platforms using a data collector integrated within an educational activity to curriculum standard mapping module, wherein the educational data includes performance data associated with educational activities undertaken by the user across the educational platforms;
normalizing the collected educational data by a normalization module operatively coupled to the data collector, wherein normalization includes providing a definition to each educational data based on the standards of a teaching curriculum;
mapping the normalized educational data, wherein mapping includes assigning weights and confidence values to the normalized educational data for identifying mastery level obtained by the user on teaching curriculum standards;
utilizing a data managing module to organize information related to mastery obtained by the user on various standards of the teaching curriculum through learning on the one or more educational platforms;
generating a standardized performance metrics of the user via the educational activity to curriculum standard mapping module based on the mapped educational data associated with educational activities of the user across the one or more educational platforms.

13. The system of claim 12, wherein the educational data may include one or more topics studied by the user, questions attempted by the user, quiz or test taken by the user on the one or more educational platforms.

14. The system of claim 12, wherein the educational data may include quizzes or tests attempted by the user outside the learning platform environment.

15. The system of claim 12, wherein collecting educational data from the one or more educational platforms further comprises utilizing a plurality of APIs by the data collector to collect educational data from the one or more educational platforms.

16. The system of claim 12, wherein receiving the collected educational data by the data normalization module further includes mapping the educational activities undertaken by the user across the one or more educational platforms to educational standards.

17. The system of claim 12, wherein mapping further comprises:
assigning the weights based on difficulty or complexity level of the educational activities undertaken by the user on the educational platforms; and
assigning confidence value to the educational data based on reliability of the data obtained from the educational platforms.

18. The system of claim 12, wherein mapping further includes assigning scores to the educational data based on performance metrics associated with the user across the one or more educational platforms for enhancing the skill and mastery level.

19. The system of claim 12, further comprising:
one or more servers for processing the educational data, wherein the one or more servers is configured for storing the educational data and the standardized performance metrics.

20. The system of claim 12, further comprising:
incorporating a network infrastructure configured for secure data transfer between the one or more educational platforms, data collector, and data normalization module, wherein the network infrastructure employs encryption protocols to ensure data security and integrity during data transfer.

21. The system of claim 12, wherein the normalization module includes a machine learning module configured to identify patterns and relationships between the educational data from the one or more educational platforms and educational standards.

22. The system of claim 12, further comprising:
a user interface to display the standardized performance metrics associated with the user and provides tools for analyzing the standardized performance metrics relative to the educational standards.
